(19) United States
(12) Patent Application Publication
(10) Pub. No.: US 2025/0366666 A1
(43) Pub. Date: Dec. 4, 2025

(54) STAND MIXER APPLIANCE POWER TAKE OFF ATTACHMENT AUTOMATIC OPERATION

(71) Applicant: Haier US Appliance Solutions, Inc., Wilmington, DE (US)

(72) Inventors: Tomas Garces, Louisville, KY (US); Katie Beachler, Jeffersonville, IN (US)

(21) Appl. No.: 18/733,370

(22) Filed: Jun. 4, 2024

(51) Int. Cl. A47J 43/044; A47J 43/07; B01F 35/212; B01F 35/22; B01F 35/222

(52) U.S. Cl. CPC A47J 43/044; A47J 43/0711; B01F 35/212; B01F 35/2202; B01F 35/222; A47J 2043/04454

(57) ABSTRACT

A stand mixer includes a housing, a motor disposed in the housing. A power take off extends from the housing, and a power take off attachment is mechanically coupled to the power take off. A controller is disposed in the housing. The controller is configured to perform a food processing operation that includes operating the motor of the stand mixer at a first speed, measuring a torque value of the motor of the stand mixer, and comparing the measured torque value of the motor to a predetermined torque threshold value. The food processing operation also includes the motor of the stand mixer at a second speed in response to the comparison of the measured torque value to the predetermined torque threshold value. The second speed of the motor is less than the first speed of the motor.

### FIELD OF THE INVENTION

The present subject matter relates generally to methods of operating stand mixers, and more particularly to methods of automatic operation of power take off attachment of stand mixer appliances.

### BACKGROUND OF THE INVENTION

Stand mixers are traditionally used for performing mixing, churning, or kneading operations involved in food preparation. Typically, stand mixers include a motor configured to provide torque to one or more driveshafts. Users may connect various utensils to the one or more driveshafts, including whisks, spatulas, or power take off attachments. Operating a stand mixer is frequently a manual process, which involves the user actively monitoring the mixing process. Thus, during the mixing process, a user is positioned close to the mixer in order to monitor the contents and to turn-off the stand mixer when the contents are process as desired. In certain mixing processes, such as processing grain, the mixing process can become undesirable as the process may be time-consuming. For a user, actively monitoring the stand mixer during the mixing process can be tedious and inconvenient.

Accordingly, a stand mixer configured to automatically operate mixing process of power take off attachments would be advantageous.

### BRIEF DESCRIPTION OF THE INVENTION

Aspects and advantages of the invention will be set forth in part in the following description, or may be apparent from the description, or may be learned through practice of the invention.

In one example embodiment, a method for operating a stand mixer is provided. The stand mixer includes a housing and a motor disposed in the housing. A power take off extends from the housing, and a power take off attachment is mechanically coupled to the power take off. A controller is disposed in the housing and is configured to measure torque of the motor. The method includes performing a food processing operation of food contents within the power take off attachment. The food processing operation includes operating the motor of the stand mixer at a first speed, measuring, by the controller, a torque value of the motor of the stand mixer, and comparing the measured torque value of the motor to a predetermined torque threshold value. The food processing operation also includes the motor of the stand mixer at a second speed in response to the comparison of the measured torque value to the predetermined torque threshold value. The second speed of the motor is less than the first speed of the motor.

In another example embodiment, a stand mixer is provided. The stand mixer includes a housing and a motor disposed in the housing. The stand mixer also includes a power take off extending from the housing, a power take off attachment mechanically coupled to the power take off, and a controller disposed in the housing. The controller is configured to measure torque of the motor and is configured to perform a food processing operation of food contents within the power take off attachment. The food processing operation includes operating the motor of the stand mixer at a first speed, measuring, by the controller, a torque value of the motor of the stand mixer, and comparing the measured torque value of the motor to a predetermined torque threshold value. The food processing operation also includes the motor of the stand mixer at a second speed in response to the comparison of the measured torque value to the predetermined torque threshold value. The second speed of the motor is less than the first speed of the motor.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a side section view of a stand mixer according to an example embodiment of the present disclosure.

FIG. 2 provides a graphical representation of data measurements recorded by a stand mixer according to aspects of the present disclosure.

FIG. 3 illustrates a flow diagram of an example method of operating a stand mixer according to aspects of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

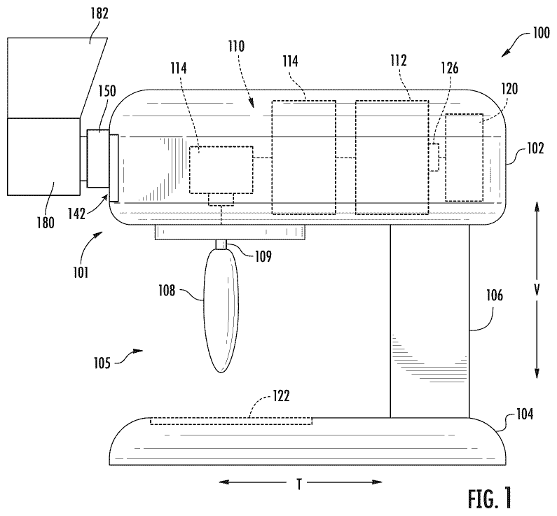

FIG. 1 provides a side, elevation view of a stand mixer 100 according to an example embodiment of the present subject matter. It will be understood that stand mixer 100 is provided by way of example only and that the present subject matter may be used in or with any suitable stand mixer in alternative example embodiments. Moreover, stand mixer 100 of FIG. 1 defines a vertical direction V and a transverse direction T, which are perpendicular to each other. It should be understood that these directions are presented for example purposes only, and that relative positions and locations of certain aspects of stand mixer 100 may vary according to specific embodiments, spatial placement, or the like.

Stand mixer 100 may include a casing 101. In detail, casing 101 may include a motor housing 102, a base 104, and a column 106. Motor housing 102 may house various mechanical and/or electrical components of stand mixer 100, which will be described in further detail below. For example, as shown in FIG. 1, a motor 112, a planetary or reduction gearbox 114, and a bevel gearbox 116 may be disposed within motor housing 102. Base 104 may support motor housing 102. For example, motor housing 102 may be mounted (e.g., pivotally) to base 104 via column 106, e.g., that extends upwardly (e.g., along the vertical direction V) from base 104. Motor housing 102 may be suspended over a mixing zone 105, within which a mixing bowl may be disposed and/or mounted to base 104.

A drivetrain 110 may be provided within motor housing 102 and configured for coupling motor 112 to a shaft 109 (e.g., a mixer shaft) or a power take off (power take off) 150. Drivetrain 110 may include planetary gearbox 114, bevel gearbox 116, etc. Mixer shaft 109 may be positioned above mixing zone 105 on motor housing 102, and an attachment 108, such as a beater, whisk, or hook, may be removably mounted to mixer shaft 109. Attachment 108 may rotate within a bowl (not shown) in mixing zone 105 to beat, whisk, knead, etc. material within the bowl during operation of motor 112.

As noted above, motor 112 may be operable to rotate mixer shaft 109. Motor 112 may be a direct current (DC) motor in certain example embodiments. In alternative example embodiments, motor 112 may be an alternating current (AC) motor. Motor 112 may include a rotor and a stator. The stator may be mounted within motor housing 102 such that the stator is fixed relative to motor housing 102, and the rotor may be coupled to mixer shaft 109 via drivetrain 110. A current through windings within the stator may generate a magnetic field that induces rotation of the rotor, e.g., due to magnets or a magnetic field via coils on the stator. The rotor may rotate at a relatively high rotational velocity and relatively low torque. Thus, drivetrain 110 may be configured to provide a rotational speed reduction and mechanical advantage between motor 112 and mixer shaft 109 and/or power take off 150.

In general, a power take off attachment 180 may be mechanically coupled to power take off 150. Power take off attachment 180 may be any suitable power take off attachment for processing food items, such as a grain mill, a sausage stuffer, a cheese shredder, a pasta extruder, etc. As such, food processing operations, as will described hereinbelow, may include one or more of grinding, shredding, and extruding food contents. In particular, power take off attachment 180 may be any suitable power take off attachment that includes a hopper 182 for holding food items for processing, such as a funnel or a container that directs food items into power take off attachment 180. In other words, power take off attachment 180 may include hopper 182 such that when performing food processing operations of food contents within the power take off attachment, the food contents within hopper 182 may be processed. Additionally, food items may be continuously added to hopper 182 such as to continue processing food items during the food processing operations. For example, the food processing operations of stand mixer 100 may include operating motor 112 in a single batch mode or a continuous batch mode, as will be explained hereinbelow.

Stand mixer 100 may include a controller 120 provided within casing 101. In detail, controller 120 may be located within motor housing 102 of casing 101. For instance, controller 120 may be a microcontroller, as would be understood, including one or more processing devices, memory devices, or controllers. Controller 120 may include a plurality of electrical components configured to permit operation of stand mixer 100 and various components therein (e.g., motor 112). For instance, controller 120 may be a printable circuit board (PCB), as would be well known.

As used herein, the terms “control board,” “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 120 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 120 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 120 may be operable to execute programming instructions or micro-control code associated with an operating cycle of stand mixer 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 120 as disclosed herein is capable of and may be operable to perform any methods, method steps, or portions of methods as disclosed herein. For example, in some embodiments, methods disclosed herein may be embodied in programming instructions stored in the memory and executed by controller 120. According to still other example embodiments, a user interface 142 may include one or more microprocessors and/or one or more memory devices. Accordingly, certain components of stand mixer 100 may be controlled directly from user interface 142.

The memory devices may also store data that can be retrieved, manipulated, created, or stored by the one or more processors or portions of controller 120. The data can include, for instance, data to facilitate performance of methods described herein. The data can be stored locally (e.g., on controller 120) in one or more databases and/or may be split up so that the data is stored in multiple locations. In addition, or alternatively, the one or more database(s) can be connected to a remote user interface (not shown) through any suitable network(s), such as through a high bandwidth local area network (LAN) or wide area network (WAN). In this regard, for example, controller 120 may further include a communication module or interface that may be used to communicate with one or more other component(s) of stand mixer 100, controller 120, an external appliance controller, an external device, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

Controller 120 may be in communication with various sensors, such as a torque meter 126. In the example embodiment shown in FIG. 1, the various sensors may include a scale 122 and torque meter 126, however, torque meter 126 may be optional, or may be omitted entirely, in other example embodiments. Controller 120 may receive signal(s) from scale 122 corresponding to a weight measurement, e.g., of the bowl and materials therein. Scale 122 as shown is an integrated scale within base 104 and is provided for example purposes only. One skilled in the art would appreciate that scale 122 may be another type of scale, e.g., a side scale, a drop scale, or a manual weight selection knob, or may be omitted entirely. It would be understood that scale 122 of stand mixer 100 may be optional in certain example embodiments. Controller 120 may generally measure torque of motor 112 while motor 112 is mixing food contents. For example, torque may be directly influenced by the state, e.g., viscosity of the mixture, and/or presence of the food contents. In particular, controller 120 measuring torque of motor 112 may include controller 120 monitoring both of current draw (Amperes) and motor speed (revolutions per minute) of motor 112 in order to calculate torque of motor 112.

In some example embodiments, controller 120 may be configured to measure a parameter of food contents in the stand mixer 100, such as weight from scale 122, as well as a measure an operating parameter of motor 112, such as torque, while motor 112 operates to mix the food contents during a mixing process. In general, the parameter of food contents in stand mixer 100 may be measured by one or both of a user input and a sensor measurement, e.g., a user may input the weight, or the ingredient type, of the food contents on user interface 142 of stand mixer 100. In general, controller 120 may be configured to reacquire the values repeatedly throughout the operation of the stand mixer 100. When the operating parameter (e.g., torque) is measured and received at controller 120, controller 120 may be configured to adjust a speed of motor 112, as will be further explained hereinbelow.

The mixing process may be generally initiated by a user by cither manually pressing a switch on user interface 142, or using an external device, such as a smartphone, wirelessly connected to controller 120 in the stand mixer 100. For example, the switch (not shown) on user interface 142 may be an electromagnetic switch or servo switch. In some example embodiments, controller 120 may include sensors configured to monitor, or take into consideration, ingredient temperature, mixer temperature, and/or altitude. As generally described above, controller 120 may be configured to operate motor 112 to provide rotational power to power take off 150 and thus to a power take off attachment 180, in order to process food contents, e.g., within power take off attachment 180, and measure the operating parameter of motor 112, e.g., the torque of motor 112, while operating motor 112 to process the food contents.

In some example embodiments, controller 120 may be further configured to record a baseline torque value for comparison with measurements while motor 112 operates to mix food contents. In some example embodiments, the baseline torque value may indicate a minimum torque value when motor 112 is operating, e.g., the minimum torque value is the torque value of operating motor 112 without processing food contents. In particular, controller 120 may be configured to compare received measurements of the operating parameter of motor 112 with the baseline torque value and use the comparison to determine a state of the mixing process. For example, determining the state of the food contents may include determining that the measured torque value is equal to the baseline torque value. In this scenario, the comparison allows for decisions, specifically, stand mixer 100 may automatically stop the mixing operation if no ingredients are detected through the comparison of the measured torque values and the baseline torque value.

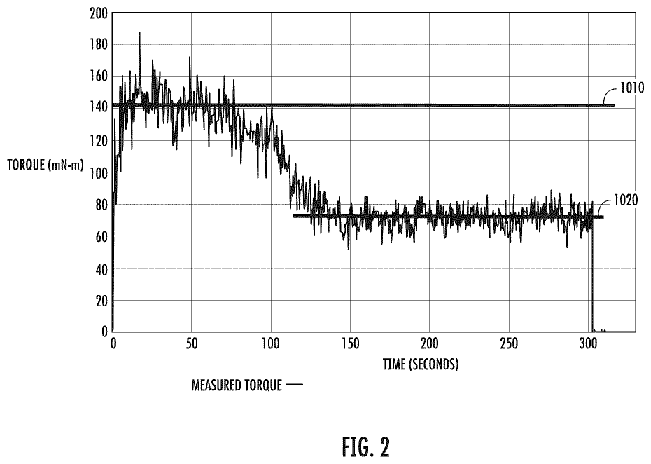

FIG. 2 provides graphical representations of example data measurements, e.g., torque over time, recorded by stand mixer 100 during a food processing operation. In particular, FIG. 2 illustrates an example embodiment of a food processing operation stand mixer 100 may be configured to perform. In general, the food processing operation may include a ramp up section at the beginning of the mixing process as power take off attachment 180 begins processing the food contents of hopper 182. In general, the torque value may be measured by controller 120 over the entire duration of the mixing process. In the present example embodiment, average torque values may measured from the torque value. In the particular example illustrated in FIG. 2, between zero seconds (0 s) and one hundred seconds (100 s), a measure torque may be measured to be about one hundred and forty two millinewton meters (about 142 mN-m) of torque exerted by motor 112 and the measured torque may be equal to or approximately equal to (e.g., within 10% greater or less than, as noted above) a processing torque threshold value 1010. For example, the processing torque threshold value 1010 may be the average torque value of motor 112 while processing food contents in power take off attachment 180.

When power take off attachment 180 nears the end of the food contents within hopper 182, the torque value may drop. After the torque drops, e.g., in the present example embodiment torque is shown dropping between one hundred seconds (100 s) and one hundred and fifty seconds (150 s), the torque may drop to a predetermined (e.g., recorded) torque threshold value 1020. For example, an average torque value measured after the torque has dropped may be equal to or approximately equal to the predetermined torque threshold. In particular, as may be seen in FIG. 2, between one hundred and fifty seconds (150 s) and three hundred seconds (300 s), the measured torque may average about seventy five millinewton meters (about 75 mN-m) of torque exerted by motor 112. In general, the drop of torque of motor 112 may indicate power take off attachment 180 has processed the food contents of hopper 182. As such, the predetermined torque threshold value 1020 may be equal to the recorded baseline torque value as described above. Processing torque threshold value 1010, predetermined torque threshold value 1020, and using the torque values in the food processing operations will be described in further detail below.

As one skilled in the art will appreciate, the above described embodiments are provided only for the purpose of explanation. Modifications and variations may be applied, other configurations may be used, and the resulting configurations may remain within the scope of the invention. For example, stand mixer 100 and the accompanying graphical representations of data measurements are provided by way of example only and aspects of the present subject matter may be incorporated into any other suitable stand mixer appliance, e.g., the time ranges and torque values described above are simply examples and the time and/or torque may vary in different embodiments and use cases of the present disclosure.

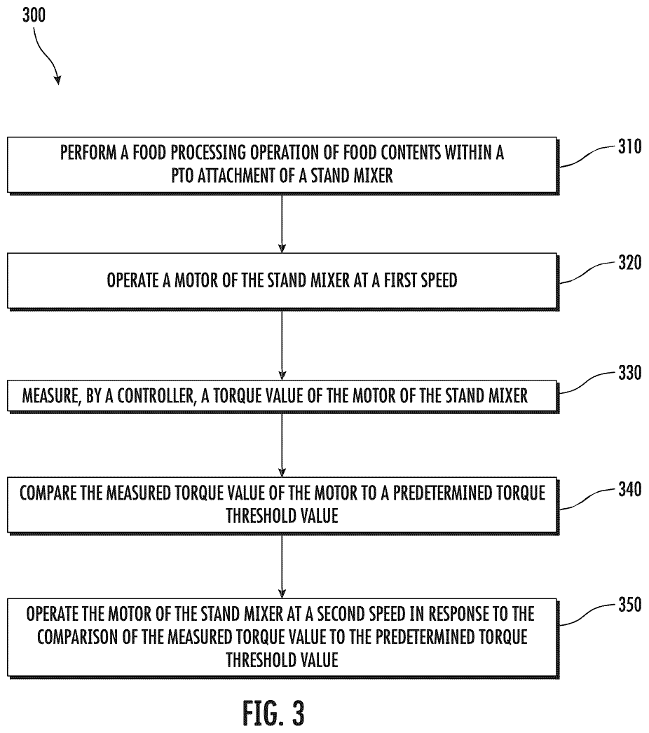

Referring now to FIG. 3, a flow diagram of one example embodiment of a method 300 of operating stand mixer 100 is illustrated in accordance with aspects of the present subject matter. In general, method 300 will be described herein with reference to the embodiments of stand mixer 100 and related elements described above with reference to FIGS. 1-2. However, it should be appreciated by those of ordinary skill in the art that the disclosed method 300 may generally be utilized in association with apparatuses and systems having any other suitable configuration. In addition, although FIG. 3 depicts steps performed in a particular order for purposes of illustration and discussion, the method discussed herein is not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 3, at (310), method 300 may generally include performing a food processing operation of food contents within the power take off attachment. For example, performing the food processing operation may include operating power take off attachment 180 to process food contents within hopper 182 of power take off attachment 180. In one example scenario, the food processing operation may include processing grains, such as rice, through a food mill power take off attachment, whereby performing the food processing operation includes processing the grains from the hopper through the food mill power take off attachment.

At (320), the food processing operation of method 300 may generally include operating the motor of the stand mixer at a first speed. For example, to process food contents from hopper 182 of power take off attachment 180, motor 112 may operate power take off attachment 180 at a first speed, such as at a “high” speed. In general, motor 112 may be able to operate at various speeds, ranging from a “low” speed to a “high” speed, where the “low” speed is slower than the “high” speed. In particular, operating motor 112 at the first speed may include a user input or a setting of the food processing operation indicative of a desired speed of motor 112. In other words, the first speed may be determined based on a user input or a predefined setting of the food processing operation. As such, in the present example scenario, the food processing operation may include processing grains, such as rice, through a food mill power take off attachment at the “high” speed in order to process the grains from hopper 182.

At (330), the food processing operation of method 300 may generally include measuring a torque value of the motor of the stand mixer. As described above, the torque value may be measured by controller 120 over the entire duration of the mixing process. In particular, the torque in the beginning of the food processing operation may be elevated from the baseline torque value while power take off attachment is processing food contents, and as the food contents in hopper 182 decreases, the torque of motor 112 may begin to drop.

At (340), the food processing operation of method 300 may generally include comparing the measured torque value of the motor to a predetermined torque threshold value, such as predetermined torque threshold value 1020, of the motor of the stand mixer. In some embodiments, the measured torque value which is compared to the predetermined torque threshold value at (340) may be an instantaneous torque value or an average torque value over a period of time, e.g., time ranges may include two seconds (2 s) to five seconds (5 s) or ten seconds (10 s) to twenty seconds (20 s). For example, as described above, the predetermined torque threshold value 1020 may be compared to an average torque value measured after the torque has dropped, e.g., the drop detected by controller 120 as when the torque value decreases from the processing torque threshold value 1010 to the predetermined torque threshold value 1020. In particular, the torque value may be equal to or approximately equal to the baseline torque value when the power take off attachment is processing without food contents, such as when the food contents in hopper 182 have run out.

At (350), the food processing operation of method 300 may generally include operating the motor of the stand mixer at a second speed in response the comparison of the measured torque value to the predetermined torque threshold value, e.g., when the comparison results in determining the measured torque is approximately equal to the predetermined torque threshold value. In general, the second speed of the motor may be less than the first speed of the motor, such as the “low” speed from the “high” speed. For example, the second speed may be a non-zero speed (“low” speed) less than the first speed, or zero speed, i.e., deactivated/stationary. In other words, operating motor 112 of stand mixer 100 at the second speed may include one of pausing motor 112 and/or stopping motor 112. For example, when operating in the single batch mode, the single batch mode may include stopping motor 112 in response to the comparison of the measured torque value to the predetermined torque threshold value, whereas the continuous batch mode may include operating the motor of the stand mixer at the non-zero speed less than the first speed (i.e., the “low” speed) or pausing (temporarily) the motor in response to the comparison of the measured torque value to the predetermined torque threshold value. In other words, the speed of motor 112 may not be dropped in response to a first instantaneous torque measurement reaching the baseline torque value, but rather method 300 monitors an average torque measurement over a period of time, where the period of time begins at the first instance of the measured torque reaching the baseline. As such, changing (dropping) the speed of motor 112 may be in response to the average torque being equal to or less than the baseline. Accordingly, method 300 may advantageously avoid prematurely dropping the speed of motor 112, e.g., in response to an outlier torque measurement, such as a momentary dip in torque.

Furthermore, when operating in the continuous batch mode, the food processing operation of method 300 may further include measuring the torque value of the motor of the stand mixer while operating the motor at the second speed (e.g., when the second speed is a non-zero speed) and comparing the measured torque value of the motor to the processing torque threshold value. When the measured torque value is equal or approximately equal to the processing torque threshold value 1010 while operating at the second speed, e.g., as determined by comparing the measured torque value of the motor to the processing torque threshold value, the food processing operation of method 300 may further include operating the motor of the stand mixer at the first speed in response to the comparison of the measured torque value to the processing torque threshold value. In other words, the torque value may be approximately equal to the processing torque threshold value 1010 while operating motor 112 at the second speed in response to an additional (or the next batch of) food contents being added to hopper 182 of power take off attachment 180. For example, in response to comparing the measured torque value of the motor to the processing torque threshold value (and the measured torque value being approximately equal to the processing torque threshold value) while at the second speed, motor 112 may be ramped back up to the first speed (the “high” speed) in order to process the (newly added) food contents from hopper 182 of power take off attachment 180.

In another example embodiment, method 300 may further include providing a user notification in response to the comparison of the measured torque value to the predetermined torque threshold value. In particular, such comparison may include determining that the measured torque value has reached the predetermined torque threshold, e.g., determining that the measured torque value is equal to or less than the predetermined torque threshold. In such embodiments, the measured torque value reaching the predetermined torque threshold value 1020 may be indicative of the food contents in hopper 182 having run out. Accordingly, stand mixer 100 may be configured to provide a user notification to a user indicative of the completion of the food processing operation. For example, an external device may be in direct or indirect communication with stand mixer 100 through any suitable wired or wireless communication connections or interfaces, such as a network. For example, the network may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL). As such, stand mixer 100 may be configured to provide a user notification to the external device, or, in other example embodiments, may be configured to provide an audible alert to the user.

As may be seen from the above, a method of operating a stand mixer may automate the operation of a food processing attachment. The stand mixer may monitor torque to automatically control the power take off attachment, such as a grain mill or meat grinder, to detect when the hopper has run out of food contents, e.g., grains, to stop, pause, or slow the motor. As such, the stand mixer may detect when processing is complete by observing torque drops. When torque drop is detected, the motor may stop (or slow down) automatically. The stand mixer may be configured to operate a single batch mode for processing one hopper of food contents, thereby stopping the motor when done, and a continuous batch mode, where the motor may slow down after each batch, and provide a user notification that the batch is complete. When more grains are added, the motor may speed up again without manual inputs from the user, via detecting a spike in torque of the motor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for operating a stand mixer, the stand mixer comprising a housing, a motor disposed in the housing, a power take off extending from the housing, a power take off attachment mechanically coupled to the power take off, and a controller disposed in the housing, the controller configured to measure torque of the motor, the method comprising:
performing a food processing operation of food contents within the power take off attachment, wherein the food processing operation comprises:
operating, by the controller, the motor of the stand mixer at a first speed;
measuring, by the controller, a torque value of the motor of the stand mixer;
comparing the measured torque value of the motor to a predetermined torque threshold value; and
operating, by the controller, the motor of the stand mixer at a second speed in response to the comparison of the measured torque value to the predetermined torque threshold value, the second speed of the motor less than the first speed of the motor.

2. The method of claim 1, wherein the predetermined torque threshold value comprises a baseline torque of operating the motor without processing food contents.

3. The method of claim 1, further comprising:
measuring, by the controller, the torque value of the motor of the stand mixer while operating the motor at the second speed;
comparing the measured torque value of the motor to a processing torque threshold value; and
operating, by the controller, the motor of the stand mixer at the first speed in response to the comparison of the measured torque value to the processing torque threshold value.

4. The method of claim 1, wherein the food processing operation comprises one or more of grinding, shredding, and extruding food contents.

5. The method of claim 1, wherein the first speed is determined based on a user input or a predefined setting of the food processing operation.

6. The method of claim 1, wherein operating the motor of the stand mixer at the second speed comprises one of pausing the motor and stopping the motor.

7. The method of claim 6, wherein the food processing operation comprises one of a single batch mode and a continuous batch mode.

8. The method of claim 7, wherein the single batch mode comprises stopping the motor in response to the measured torque value of the motor approximately equal to the predetermined torque threshold value, and the continuous batch mode comprises operating the motor of the stand mixer at the second speed or pausing the motor in response to the measured torque value of the motor approximately equal to the predetermined torque threshold value.

9. The method of claim 1, further comprising providing, by the controller, a user notification in response to the comparison of the measured torque value.

10. The method of claim 1, wherein the power take off attachment comprises a hopper, wherein performing the food processing operation of food contents within the power take off attachment comprises processing food contents within the hopper.

11. A stand mixer, comprising:
a housing;
a motor disposed in the housing;
a power take off extending from the housing;
a power take off attachment mechanically coupled to the power take off; and
a controller disposed in the housing, the controller configured to measure torque of the motor and to perform a food processing operation of food contents within the power take off attachment, wherein the food processing operation comprises:
operating, by the controller, the motor of the stand mixer at a first speed;
measuring, by the controller, a torque value of the motor of the stand mixer;
comparing the measured torque value of the motor to a predetermined torque threshold value; and
operating, by the controller, the motor of the stand mixer at a second speed in response to the comparison of the measured torque value to the predetermined torque threshold value, the second speed of the motor less than the first speed of the motor.

12. The stand mixer of claim 11, wherein the predetermined torque threshold value comprises a baseline torque of operating the motor without processing food contents.

13. The stand mixer of claim 11, wherein the controller is further configured to:
measure the torque value of the motor of the stand mixer while operating the motor at the second speed;
compare the measured torque value of the motor to a processing torque threshold value; and
operate the motor of the stand mixer at the first speed in response to the comparison of the measured torque value to the processing torque threshold value.

14. The stand mixer of claim 11, wherein the food processing operation comprises one or more of grinding, shredding, and extruding food contents.

15. The stand mixer of claim 11, wherein the first speed is determined based on a user input or a predefined setting of the food processing operation.

16. The stand mixer of claim 11, wherein operating the motor of the stand mixer at the second speed comprises one of pausing the motor and stopping the motor.

17. The stand mixer of claim 16, wherein the food processing operation comprises one of a single batch mode and a continuous batch mode.

18. The stand mixer of claim 17, wherein the single batch mode comprises stopping the motor in response to the measured torque value of the motor approximately equal to the predetermined torque threshold value, and the continuous batch mode comprises operating the motor of the stand mixer at the second speed or pausing the motor in response to the measured torque value of the motor approximately equal to the predetermined torque threshold value.

19. The stand mixer of claim 11, wherein the controller is further configured to provide a user notification in response to the comparison of the measured torque value.

20. The stand mixer of claim 11, wherein the power take off attachment comprises a hopper, wherein performing the food processing operation of food contents within the power take off attachment comprises processing food contents within the hopper.
